(19) United States
(12) Patent Application Publication
(10) Pub. No.: US 2014/0337145 A1
(43) Pub. Date: Nov. 13, 2014

(54) METHODS, DEVICES AND SYSTEMS FOR GREEN CONTENT MANAGEMENT AND IMPROVING GREEN PROCUREMENT

(71) Applicant: GreenStarHub, Inc., Forest Hills, NY (US)

(72) Inventor: Tam A. PHUNG, Woodside, CA (US)

(73) Assignee: GreenStarHub, Inc., Forest Hills, NY (US)

(21) Appl. No.: 13/888,561

(22) Filed: May 7, 2013

(51) Int. Cl. G06Q 30/02; G06Q 50/00

(52) U.S. Cl. CPC G06Q 30/0277; G06Q 50/01
USPC 705/14.73

(57) ABSTRACT

A computer-implemented method for a mobile computing device to provide environmental information may comprise detecting a location of the mobile computing device within or adjacent to a building or structure; accessing a remote database over a computer network; querying the accessed database based on the detected location; receiving environmental information associated with the building or structure from the database over the computer network; and selectively displaying the received environmental information based upon received user selections. The database may comprise, for example, building information model (BIM) information.

### BACKGROUND

In construction there has been much interest in new LEED or environmentally-friendly (hereafter, “green”) construction and retrofits to meet mandates to reduce energy and water usage. For example, special design methods are used by sustainability designers to take advantage of natural light and drain off. Moreover, healthy materials, EnergyStar appliances, water efficient, low volatile organic compound (VOC) paints, high efficient heating and air conditioning units, and light-emitting diodes (LED) lighting are a few examples of building products that are used in the furtherance of the goal of reducing the environmental impact of construction, maintenance and on-going operation of buildings, structures and businesses.

Since green materials and processes are not immediately apparent to casual observers or potential customers, building or business owners try to publicize their sustainability and green efforts by erecting signs or plaques highlighting Gold LEED compliance, green ratings, and the like. For example, a decal might be applied to the front door of an establishment, informing the user that the establishment has installed a roof-top solar system.

### BRIEF DESCRIPTION OF THE DRAWINGS

FIG. 1 shows a diagram of a web-accessible dashboard for aggregating and showcasing sustainability efforts, objectives and achievements, according to one embodiment.

FIG. 2 is a block diagram of a method of disseminating selected environmental and sustainability information, according to one embodiment.

FIG. 3 is a diagram illustrating further aspects of one embodiment.

FIG. 4 is a diagram illustrating a computer-implemented method according to one embodiment.

FIG. 5 is a diagram of a computing device with which embodiments may be practiced.

### DETAILED DESCRIPTION

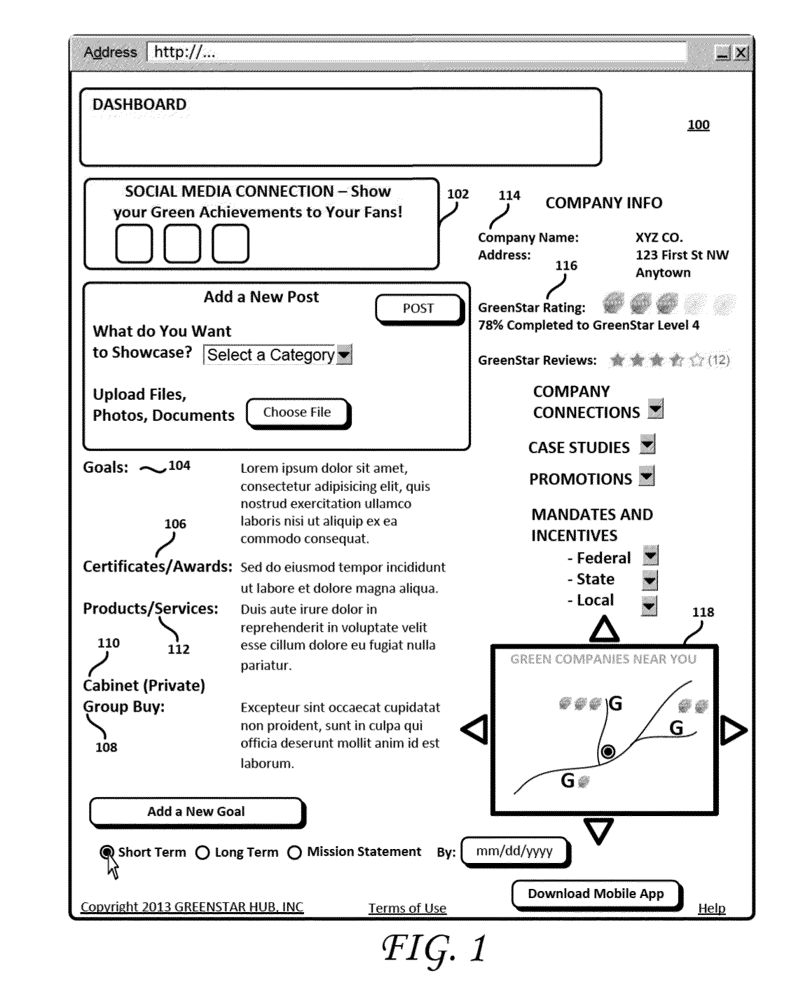

Small and large corporations alike need to organize and provide a centralized location for aggregating and showcasing their sustainability objectives (short and long term goals and mission statements), actions (e.g., recycling programs) and green achievements (such as, for example, awards, implemented projects, purchases) and GreenStar (GS)-rated products and/or services. Integration with social media web sites is also significant, as such integration contributes to the sharing of such objectives, achievements, and challenges. One embodiment, therefore, comprises a web-accessible centralized online location for aggregating and showcasing sustainability efforts, objectives and achievements. FIG. 1 is a diagram of a web-accessible dashboard for aggregating and showcasing sustainability efforts, objectives and achievements, according to one embodiment. As shown therein, the dashboard 100 may be configured as a front-end of one or more repositories of an individual or a business' environmentally-friendly and sustainability (hereafter, “green”) efforts, goals 104 and achievements. FIG. 1 shows an exemplary dashboard 100 according to one embodiment. However, it is to be understood that the layout and content of the dashboard 100 may differ significantly from that shown in FIG. 1. Keeping the foregoing in mind, the dashboard 100 shown in FIG. 1 may comprise a social media connection 102, through which the user may post various green achievements to various social media sites. The user, for example, may “sign-in” to his or her dashboard via a social media site, such as, for example, Facebook or LinkedIn. Changes to the dashboard 100 may also be tweeted to Twitter, for example. Indeed, according to one embodiment, connecting the database(s) supporting the dashboard 100 may be carried out by leveraging existing social media platforms such as Facebook, Linkedin, Twitter, YouTube, Google applications (maps, business directories, etc.), aggregated or group buy applications, and the like. For example, a business owner, through the dashboard 100, may tweet that he or she successfully obtained Gold LEED certification on his or her building. Also, the dashboard 100 may be configured to enable a manager to post ambitious green goals and achievements on the company fan page of a social media site. Each business or individual that configures a dashboard such as shown at 100 in FIG. 1, may be considered to be a “member”. A social media application may be provided, for example, to integrate members and their dashboard pages with the company fan page on one or more social networking sites.

According to one embodiment, the dashboard 100 may also be configured to showcase an individual's or a company's green certificates, certifications (such as the United States Green Building Council LEED scoring of platinum/gold/silver projects, green-e, Masdar's The Future Build's Estidama Pearl ratings, the Building Research Establishment Environmental Assessment Method (BREEAM), the World Travel and Tourism Council's Green Globes, the International Code Council's International Energy Conservation Code, the McDonough Braungart Design Chemistry's Cradle to Cradle) and awards (green building design awards) or best practices (a white paper written up describing the process used), as shown at 106. Members desiring to purchase specific green products or services may group together in an effort to reduce the price of such products and/or services through the increased purchasing power of the group in the manner, for example, disclosed in commonly assigned and co-pending U.S. application Ser. No. 13/312,059, entitled “Aggregated Customer Grouping” filed on Dec. 6, 2011 and U.S. application Ser. No. 13/705,504 entitled “Methods, Devices And Systems For The Generation Of Requests For Quotes From Aggregated Construction-Related And Permitting Information” filed on Dec. 5, 2012, the disclosures of which are incorporated by reference herein in their entirety. According to one embodiment, procurement managers may create a buying group with customized invitations to members and the progress of such group buy efforts may be chronicled at 108. Ad-hoc buying groups may be formed at the request of a predetermined number of customers or according to other criteria.

Some information may be kept private (e.g., receipts, plans) and kept in a Cabinet 110 that is only selectively accessible to the member. Other information may be maintained public, such as the installation of solar panels, grey water recycling, etc. If offered, green products and/or services available for sale may be highlighted at 112.

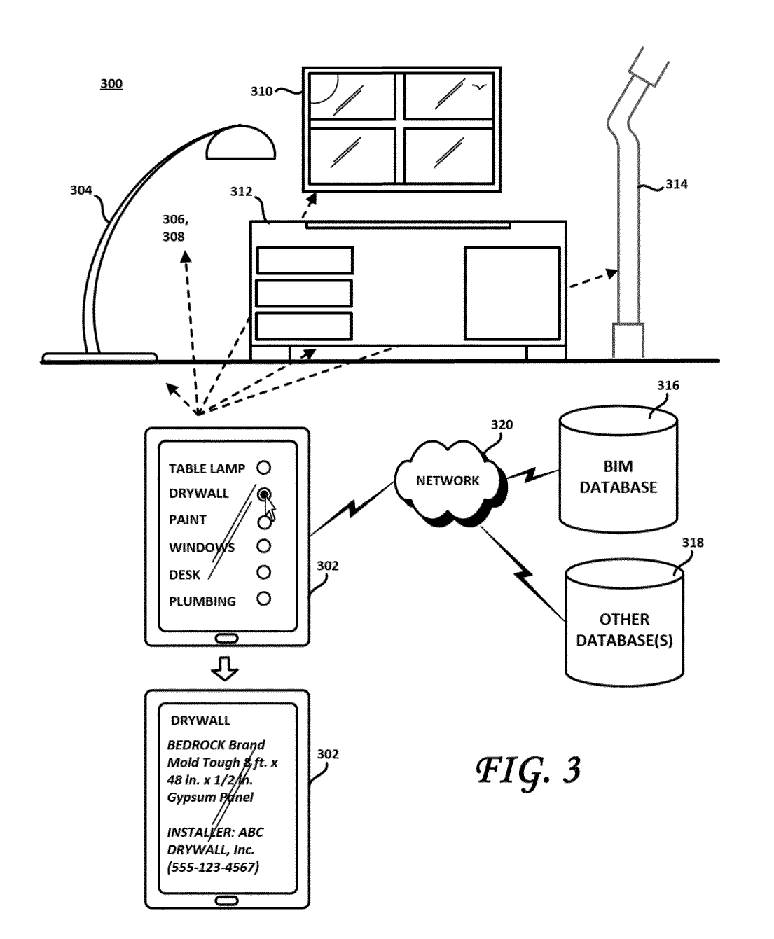

According to one embodiment, the dashboard 200 may be configurable by the user according to a variety of different categories of information. Such information may be stored in one or more databases selectively accessible over a computer network, from which the dashboard 100 draws the desired and user-configurable green information. For example, the dashboard 100 may display the company name and profile 114, which may be populated upon registration and/or may be drawn from an external source, such as a fan page or from information from a social networking site and/or other public or licensed databases, for example. According to one embodiment, businesses may be rated, as shown at 116, according to a “green rating” scale. The dashboard 100 may also display the desired green rating and the current green rating. In the exemplary embodiment of FIG. 1, the green rating is shown on a scale from one to five leaves. The database from which the dashboard 100 draws may also store key data regarding the factors that may be keeping a business from achieving a desired green (e.g., 5 leaves) rating. Such information may be collected, for example, from stakeholders in the business. Also, financial constraints that may be preventing the business from achieving its desired green rating. The information concerning such financial constraints may originate from, for example, public and private individuals/entities that provide or determine cash flow, debt ratio and credit scores, for example. Information from such sources may be evaluated to enable a ranking engine to rate the member's ability to successfully execute their green goals, invest in green capital equipment and/or otherwise achieve a higher green rating. Other information that may be stored in the database from which the dashboard draws may include, for example, market growth information, return on investment (ROI) information, incentives, infrastructure and/or structural limitations, technology readiness and product availability, for example. Moreover, customers, suppliers, banks, and government agencies may have insight on what the businesses' green intentions are and may decide to invest in or buy from those businesses that meet their green guidelines. The database(s) supporting the dashboard 100 (shown at 316, 318 in FIG. 3) may also store information regarding the headquarters of the business in question and all of its remote locations, for example, as well as any other relevant information.

In addition, the database(s) may be configured to store and the dashboard 100 may be configured to selectively display information of a member's green products and/or services and/or of the green products and services of other members. A filing cabinet 110 may be provided, where the member may store and selectively cause to be displayed information that is to be kept private or at least only selectably viewable by others. Such private or restricted information may comprise, for example, Requests for Quotes (RFQs) in a group buy, private reports and purchases. Moreover, rewards and records of incentives and rebates may be kept in the private filing cabinet 110 or elsewhere. Embodiments may be configured to monitor the status of permit application processes and scrape permit information from federal, state and local databases as allowed, for storage in the database(s) supporting the dashboard 100. From this information, one embodiment enables the creation of RFQs based on, for example, approved permits and keywords. In so doing, one embodiment enables members to market to property owners, project managers and, for example, designers who are involved in the permitting and pre-project processes.

One embodiment enables integration with both existing social media such as to enable Facebook “like” and/or Google's “google+1”. In addition, a “+green” or functionally similar approval mechanism may be implemented for the dashboard and/or other “green” sites, enabling the member to signal his or her approval of the environmental worthiness of some product, service or other member. The leaf rating system shown in FIG. 1 may be supported by enabling members to post wish lists, pictures, videos and/or observations or ideas related to their current or desired leaf rating. According to one embodiment, if the social media approvals (e.g., likes, +1 or +green) reach a predetermined level, the member's leaf rating may be adjusted accordingly. According to one embodiment, the dashboard 100 may be user-configurable to enable scorecard categories, which may comprise categories and subcategories selected by the member and/or his or her admin as being relevant. Such scorecard categories may comprise and showcase achievements, status, goals in the fields of, for example, policy and planning, design and construction, operations and maintenance, energy management, energy efficiency, renewable energy, smart power, grid storage, water management, air management, food and recycling management, green information technology (IT), transportation, greenhouse emissions, green investments, recognition of green companies and identification and promotion of green funds, to identify only a few of the possibilities.

According to one embodiment, the database supporting the dashboard 100 and the dashboard 100 may comprise and make selectively available public and proprietary software tools, case studies, research and RSS news feeds. The dashboard 100 may be configured for access by a mobile device and may provide access to the member's email. Links to other member's dashboards may be provided, as well as access to other unaffiliated green websites. Downloading documents may be enabled, as may be the uploading, by suitably authenticated members, of documents to the filing cabinet 110. Such documents may comprise, for example, purchase receipts, specs and plans, online evaluations and onsite reports, RFQs, pictures, videos, an identification of green strategic partners, internal departments (e.g., colleges within universities), external companies, buying partners (in a group buy situation, for example) and green channel partners. The mobile device, according to one embodiment, may be, for example, an iPhone, android, iPad, iPad-mini, iWatch, Google Glass, RFID device or wand, or a transmitter in a vehicle to identify but a few possibilities. The mobile device may be battery powered, or may require a plug-in power source. The mobile device may transmit location information via GPS, via a cell phone tower network, or by some kind of near field communication protocol, for example. The mobile device may be coupled to the internet via a cell phone network (e.g., LTE network), wireless fidelity or a direct hardwired connection. The data packet may comprise an email or any other electronic message.

Advertisements may be created and presented on the member's dashboard 100. The dashboard 100 may be configured, according to one embodiment, to designate and control the dissemination and availability of such advertisements, based on, for example, the deal, product or service, the end buyer, the location of the potential buyer, an affiliate relationship, and a group buying opportunity such as green partners and other rated companies. The advertisements may be integrated with LinkedIn or other social network groups, mobile platforms and emails. The advertisements, moreover, may be directed to members participating in RFQs, wish lists, requests for information (RFI). The dashboard 100 may also be configured for displaying and sharing best practices and any other information that the member wishes to share with others and/or aggregate. For example, the dashboard 100 may be configured to showcase people and organizations that the member wishes to follow's to follow, profiles of the member or others and/or his or her organization, which may be helpful in creating group buys and/or generating sales leads. According to one embodiment, each group buy may comprise or be assigned a group buy unique identifier that may be termed, for example, a Group Identification Number of GIN. According to one embodiment, each group buy may be assigned a new and unique GIN. The GIN may be configured, according to one embodiment to comprise or otherwise refer to all identification information that is pertinent to a particular group buy. This may include, for example, relevant dates, participants, what is being purchased or leased, conditions, terms and the like. The GIN may be prefixed with a metadata tag such as, for example, the symbol “*”. The members of a group buy or the originator thereof, may choose to make a particular group buy public or private. Public group buys may be selectively seen by others and may be selectively joined by others. For example, other may join a pre-existing group buy by causing the execution of a, for example, Join Group Buy command, which may take a GIN as argument. For example, a member wishing to join a particular group buy may issue or cause to be issued a command of the form JOIN (*GIN). If the member satisfied the criteria for joining the group buy and if the group buy identified by the *GIN is open to new participants, the member may be allowed to join the group buy. According to one embodiment, the ability to join existing group buys (via the Dashboard 100, for example) through the *GIN and the Join command (for example), may cause deals that would not have otherwise closed to close and/or may cause deals that would have closed anyway to close faster than they otherwise would have. According to one embodiment, rather than joining a pre-existing group buy, two or more group buys may be joined together. Indeed, it may be desirable to keep group buys separate for any number of reasons, including options (i.e., different colors, characteristics), different geographical locations, different delivery dates, credit terms, and the like. *GINs may comprise other *GINs, to denote a group of group buys.

For example, a member may notice that a group of nearby businesses have established a group buy, identified by a *GIN such as *GB22423DATE. Alternatively, the member may receive an electronic message from one or more of these nearby businesses, inviting the member to join *GB22423DATE. The member may bring this group buy opportunity up on the Dashboard 100 (or may be texted or otherwise electronically messaged the group buy information) and examine all details thereof and decide whether or not she wants to join *GB22423DATE. Other implementations are possible.

According to one embodiment, group buys. RFQs and projects may be associated with a building, group of buildings, complex or other physical, geographical, jurisdictional or legal grouping. For example, a building owner, motivated perhaps by present or future federal, state or local mandates or incentives, may plan on buying 20 LED light bulbs. The building owner may either create a new group buy or search for other existing group buy opportunities that were previously created to purchase such LED light bulbs in bulk. Such existing group buys may have been originated by other similarly-situated building owners and may have been motivated by either applicable present mandates or future mandates applicable to buildings such as his own building. Should the building owner (or other stakeholder) decide to join an existing group buy, he may do so using the Join mechanism outlined above, and increase the effective purchasing power of that existing group buy. Alternatively, the building owner may start a new group buy, make it public and invite other similarly-situated building owners or stakeholders to join in this new group buying opportunity. According to one embodiment, therefore, the existence of the group buys and the public visibility of the planned purchases may be effective to cause vendors (LED light bulb vendors, in this case) to sell more, with greater frequency and with better returns than would otherwise be possible.

According to one embodiment, the entity that hosts the Dashboard 100 and/or the group buys or green ratings may decide to modify some of the terms of the group buy, to ensure that group buy triggering targets are met sooner and/or that the group buy does not fail for some avoidable reason. For example, the fee collected for such a group buy may be lowered to ensure that the effort does not fail if pricing targets are very close to, but do not reach, a group buy execution threshold.

One embodiment is tightly integrated with location services such as that provided by the Global Positioning System or GPS. One embodiment may be specifically configured for mobile devices and other location-aware devices. Such devices may comprise, for example, smart phones, tablets, smart watches and other devices that include at least outdoor location awareness. One embodiment integrates with indoor location (e.g., GPS) functionalities. Moreover, selected functionalities may be made available to mobile and location-aware devices through an “App”, which may be developed for the specific platform of the device (e.g., Android, Apple, Facebook, etc.).

According to one embodiment, such an App may be configured to enable customers and businesses to communicate information that leverages GPS information, green ratings, aggregation and/or group buying opportunities. For example, the dashboard 100 and the database(s) supporting the dashboard 100 may be configured to enable customers (e.g., members) of a predefined rating level (e.g., 4-5 leaf rating) to identify and contribute to those companies who have similar green ratings. The dashboard 100 may also be configured to enable others to become informed regarding special promotions on green-rated products and services that are located in close geographic proximity. In this manner, the App may reward those businesses with higher green ratings. However, the App may also be configured to promote investments or purchases from those lower green-rated businesses that have the most potential to improve, such as promising business having a 1-2 leaf rating, for example. Embodiments may be configured to track online/offline clicks or traffic, number of click-throughs and amount of sales in a partner or affiliate program in which a certain amount per event (click-though, inquiry, sale) is paid. In this manner, the dashboard 100 may be configured as a platform for merchants to create ads and reward based on click and purchase performance.

### Example

A customer is traveling and checks his/her smartphone App according to one embodiment for local businesses that are close to her current location. The customer pulls up a dashboard 100 and sees member several coffee shops in the area with different green ratings, as shown at “G” at reference 118. She clicks on the 3-leaf coffee location because it has a high green rating and because this coffee shop currently has a special on a recycled coffee mug that she wants to buy as a gift. She may then be prompted to “check in” and uses her credit card to make the purchase. The credit card company may then send some information related to the purchase back to the member company. Such information may affect the company's green rating and may result in a payment from the member company to the company administering the dashboard 100 and the mobile App. Continuing, the customer, while waiting in line at the selected coffee shop, in line, may have spotted a non-green (or otherwise unrated) product for sale, such as an espresso coffee maker. The customer may not want to purchase this item unless a discount can be arranged. According to one embodiment, the customer may signal, on her App, her desire to become part of a group buy effort, in which several potential buyers are aggregated to purchase several such espresso makers, given predetermined price and delivery constraints. The App may be configured to add her to a group buying list or to start a new group buying list. While the espresso maker is on the group buying list, the App may be configured, according to one embodiment, to look for comparable products, perhaps at a better price and exhibiting greener qualities. The customer may also be enabled by the App to invite or allow others nearby or far to join into the group and to present the group to the seller.

According to one embodiment, the integration of GPS, green-rated customers, businesses and products, group buying, wish lists, social networks, credit card purchase information feedback enables effective marketing and rewards programs for merchants. This integration creates more opportunities for deals to close due to the transparency of green characteristic of businesses products and purchases. Such deals presented to customers may be represented in banner ads, dedicated green ads on mobile devices, Facebook fan pages, the dashboard 100, mobile Apps, tweets and text, for example.

According to one embodiment, effective tracking of purchases enables more accurate and automated tuning of green ratings of the business and rewarding those who actually contributed to a business' increased green rating. In other words, rewards may flow, according to one embodiment, both to those who have a higher green rating and also to those customers who invest (via purchases, for example) towards a company's sustainability.

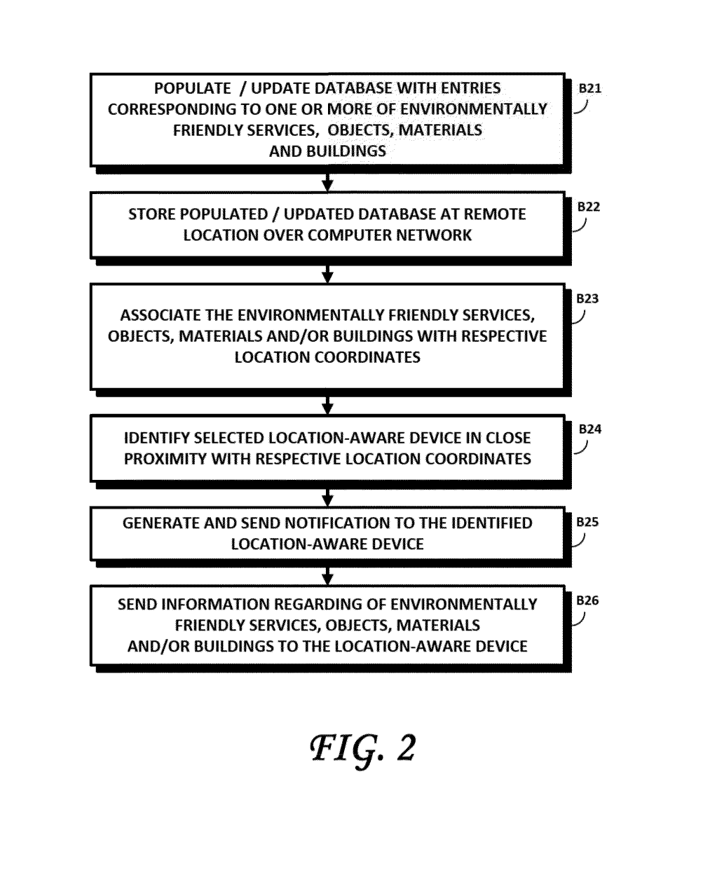

FIG. 2 is a block diagram of a method of sharing selected environmental and sustainability information, according to one embodiment. According to one embodiment, therefore, a computer-implemented method of sharing or disseminating selected environmental information may comprise populating a database with entries corresponding to elected environmentally-friendly services, investments, objects, materials and/or buildings, for example, as shown at B21 in FIG. 2. As shown at B22, the populated database may then be stored at a remote location over a computer network, such as the Internet, for example. Block B23 calls for one or more of environmentally-friendly services, objects, materials, buildings, group buys, RFQs or projects to be associated with respective location coordinates (e.g., GPS coordinates). A location-aware device (e.g., smartphone, tablet, etc.) in close proximity with the respective location coordinates may then signal its presence and proximity (or otherwise cause a central server to detect such presence/proximity) as shown at B24, whereupon a notification may be generated at B25 to the identified location-aware device and information regarding the environmentally-friendly services, objects, materials and/or buildings may then be sent building to the location-aware device, as shown at B26.

The information sent to the location-aware device may be pushed to the device or may be generated and sent responsive to a query from the location-aware device. The information, for example, may comprise information regarding the services, objects, materials and/or buildings that satisfied, alone or in combination, local, state and/or federal mandates and/or incentives. According to another embodiment, the information sent to the location-aware devices may comprise information regarding manufacturers or installers of the objects, materials and buildings or Building Information Models (BIMs). In this manner, such green businesses may be promoted by virtue of standing physical structures and products with which consumers may come into contact with in their daily lives. According to one embodiment, populating the database may comprise storing dates at which the selected environmentally-friendly services, objects, materials and buildings were implemented, purchased or otherwise brought into existence. According to another embodiment, populating the database may comprise storing Building Information Model (BIM) information in the database. Such BIM information may then be used to enable the sending of information regarding environmentally-friendly materials and/or green building processes to the location-aware device. Databases of buildings (address, owner, specifications, age, etc.) or business location (i.e., Starbucks) exist publicly and are freely available or are available for licensing. The contents of such databases may be used to populate the database(s) supporting the dashboard 100.

According to one embodiment, GPS or other location services may be leveraged to enable the customer to point his or her mobile device-integrated camera toward a green building and receive information regarding the building materials, the builder, green building processes used in its construction, and like construction-related information. Likewise, interior GPS may enable an App according to one embodiment to recognize green (e.g., geo-tagged) products or services on display or otherwise available within a member establishment and provide sustainability information regarding that product or services. FIG. 3 is a diagram illustrating additional functionality of one embodiment. As shown therein, reference numeral 300 represents the inside of a retail establishment or other place of business. Reference 316 represents a BIM database and 318 another database that store information used by the dashboard 100. Such databases 316, 318 may be accessible via a network 320 comprising, for example, the Internet. Reference 302 denotes a mobile computing device executing an App configured to display and allow interaction with the dashboard 100. According to one embodiment, the user may utilize the mobile computing device 302 and the App loaded thereon to query the BIM and other database(s) regarding the brand, model, specifications, prices, service providers and the like associated with items within the retail or business establishment. For example, the mobile computing device 302 (or any other mobile computing device) may be pointed at table lamp 302, the drywall 306 or paint 308, the window 310, the desk 312 or even the plumbing 314, even if not visible through the sheetrock and paint. Using the mobile computing device's camera, ability to resolve and integrate indoor GPS coordinates and orientation (e.g., compass and tilt) information and even dead reckoning information, the App may be configured, according to one embodiment, to enable the user to select any of these items to learn further information thereon. In the example of FIG. 3, the user has selected the business' drywall as the item of interest. As shown in FIG. 3, selecting the drywall may bring up additional information concerning the drywall used in this establishment, including brand, size and specifications, together with the name and contact information of the drywall installer having installed this expanse of drywall in this business establishment, at least to the extent that such information is available in the databases 316, 318. Instead of lists of items, the available information may appear superimposed on the items as the tablet computing device is pointed towards the items of interest. Targeted offers and advertising may then be pushed or offered to the user, based on his or her selections within the App. In this manner, the brick-and-mortar green establishments themselves may function as virtual catalogs of available green products and services. In turn, this enables, for example, a builder to automatically generate a catalog of his or her work that potential customers can experience first-hand, in the offline, physical world. Embodiments, therefore, enable online marketing (e.g., from mobile devices or ecommnerce sites) of building information comprising, for example, building specifications in the BIM, which may contain comprehensive building data down to the brand of materials, the manufacturer or installer, when such materials or capital improvements were installed, including energy ratings, models, incentives and mandates such as, for example, Title 24 for the state of California or LL87 for New York City.

According to one embodiment, the App may be launched from a mobile location-aware device (e.g., smartphone or tablet computer) using proximity platforms such as Google maps, Foursquare and/or indoors GPS. The information stored that may be associated with a building may include, for example, infrastructure in the ground to promote, for example, the fact that a master developer may have used a green water draining system. Transportation systems (electric cars, boats, planes, etc.) may be adapted with similar information regarding their green building, maintenance and operations. Alternatively, a business name or location may be entered into the App and building information (e.g., BIM, other CAD specs, pictures, videos) may be provided. Requests for such information may be made and suitable information may be provided via the App, texts, videos, simulations and/or voice, for example.

The information provided may be remotely stored (i.e., in the cloud) in one or more databases and transmitted to mobile devices, onboard systems (i.e., OnStar in autos) using 3G, 4G, Wi-Fi, or other protocol.

Service providers (architects, designers, contractors, subcontractors, engineers) and vendors (OEM's, distributors, handlers) may utilize the dashboard 100 to share and showcase completed green projects or green products purchased for case studies or marketing to potential customers viewing the business or building. For buildings, the materials used, which are not readily visible either by occupants or passersby, may be detailed in the dashboard 100 or in the corresponding mobile device App. Such information may include, for example, insulation behind walls, brands of products, a solar on a rooftop, paint color or certification, LEED certifications points awarded, the confirmation of the criteria (reduces waste, low VOC, etc.) met in order to obtain the LEED certifications points, smart temp controls, as well as healthy materials, green processes, approaches and strategies.

Building owners and businesses may want to increase consumer awareness of their green efforts, achievements and investments. Retail businesses may want to market products that are green at their business location (whether indoors or outdoors). For example, a large retailer may sell smart thermostats and a car dealer's inventory may comprise electric vehicles. For example, green items or services listed on the dashboard 100 may be geo-located (using indoor GPS, for example) in a retail environment such as, for example, a big box store. Thereafter, customers may be encouraged to search for and find a number of these items using clues from a mobile App. Such functionality may be incorporated into a scavenger-type game or other educational activity, whereby a mobile device (smartphone, tablet, wand, etc.) may be configured to retrieve information at a particular location about a particular product (i.e. recycling bin, Energy Star lighting fixtures, etc.) A transmitter (battery-powered or hardwired) may be configured to broadcast a signal to the mobile device containing such information or a link from which pertinent information may be downloaded. A passive implementation may include the use of barcodes (traditional or 2-D barcodes) or equivalent machine vision mechanism. Radio-Frequency Identification Devices (RFIDs), whether passive or active, are another example of such a transmitter. The transmitter, according to one embodiment, may transmit location information through the Internet, Wi-Fi or through some near field communication protocol. Points, credits or discounts may be awarded for finding a selected one or a predetermined number of these green items or services for sale. Points, credits or discounts may also be awarded for finding green characteristics of the building, in various categories such as, for example, energy, water, healthy materials, etc. In this manner, the retailer may not only increase awareness of its own green inventory in a fun, interactive manner, but may also increase customer awareness of its installed infrastructure, to further increase customer goodwill. Such an embodiment may be configured to assist in increasing outreach or awareness of green projects. The data may also be organized into database format and made accessible to programmers via an Application Programming Interface (API) for customized software solutions. For example, within the context of an architectural design tool, an architect may walk up to a building, and query the details on a particular building element, and then be able to load that element into one of their designs.

For example, within the context of group buys discussed above, a person may walk up to a building comprising a transmitter, as described herein. Such a transmitter may, for example, broadcast, or otherwise cause to be displayed on the person's mobile device (over a computer network, for example), a message detailing an on-going group buy opportunity, perhaps to satisfy some existing or future mandate or to take advantage of some soon-to-expire incentive program. The on-going group buy opportunity may have originated with the building owner or the building owner may have joined a pre-existing group buy. This group buy opportunity may be joined by the person approaching the building or by stakeholders of a nearby building. That person and/or a stakeholder of one of the neighbors may then request to join the existing group buy using, for example, the Join (*GIN) mechanism described above. In this example, the group may grow sufficiently to justify transitioning the planned purchase from, for example, an 18-month lead time, T1 procurement to an immediate purchase via, for example, a reverse auction.

According to one embodiment, therefore, by maintaining building information, mandate, certification, rating and incentive information (among other types of information), and group buy information, purchasing patterns may be changed, by providing access to relevant information and providing the infrastructure to enable dynamic group buy opportunities, optionally with long lead times to satisfy future mandates that may not go into effect for a relatively long time.

According to one embodiment, the green rating 116 may be a graphical representation of the number of points or credits accumulated towards a goal of the business or building owner. This green rating may then be used to good advantage, together with other information stored in the database(s) supporting the Dashboard 100, to auto-generate group buy opportunities or deals based, for example, on the information stored in the databases and the desired green rating and the member's stated goals. Auto-generated group buy opportunities or deals may also be based and/or patterned after other similarly-situated building stakeholders who have previously generated compatible group buy opportunities or that may have been presented with similar deals. For example, knowing that the goals of a business or organization is to achieve net zero energy use and to reduce water use by 30% by 2020 and their present green rating status, the business may be presented with relevant deals (products, services, group buys and deals), thereby giving them better options and the opportunity to aggregate their purchasing power. According to one embodiment, the goals need not be all green-related. For example, one of the business' goals may include buying 20% more from minority or women-owned businesses, for internal and/or government related reasons. Such content may be maintained in the database(s) supporting the Dashboard 100 and selectively and appropriately shared.

According to one embodiment, the dashboard 100 may be configured to enable specifiers (e.g., designers and architects that pick building materials such as furniture, insulation materials, paint and the like for incorporation into a construction or remodel project) to select building materials and furnishings that have been pre-validated in terms of their environmental impact. Accordingly, such specifiers may consult the dashboard 100 to pick pre-vetted green materials and furnishings, to achieve a desired LEED rating, for example. Within broad categories of materials and furnishings, the specifiers may pick from specific brands of green products and services and may be exposed to brands that would not have occurred to them but for the dashboard 100. According to one embodiment, therefore, with the BIM or equivalent end-to-end model for the building or site, information such as product type or brand used in the construction, previously only compiled in a case study and not widely disseminated, may be shared with a visitor, via a suitably-configured dashboard 100.

The information stored in the database(s) supporting the dashboard 100 may comprise time stamps and/or other validity/verification of information. Selectively, the dashboard 100 or portions thereof may be open to the public or selectively restricted (owner only, members only, government and owner only, people within a predetermined radius, corporate only, specifying professionals, among other possibilities) via an App or program.

For example, the content displayed in the dashboard 100 may include awards, certifications (LEED Platinum, Pearl, Estidama, green-e and the like), goals met (e.g., products or building not LEED-certified but has latest green technology), applicable mandates (the term as used herein denotes both mandates that are currently in-force (“present mandates”) and mandates that have yet to take effect (“future mandates”), permits, incentive programs, awards (e.g., green building design award), best practices (may include, for example, a link to a white paper written to describe the process utilized) and/or products for sale meeting certain criteria. Such information may be useful for a sales person or owner that is looking to close more sales or save more. Moreover, the content displayed in the dashboard 100 may comprise building characteristics (e.g., building type, age, envelope information, energy statistics and the like), as well as business characteristics (may also include non-green characteristics) such as, for example, minority owned, women owned, union, dog friendly, baby friendly, non-governmental organizations, B-Corp, educational institution, and the like.

According to one embodiment, a building owner, having imported and/or input building information into the database supporting the dashboard 100, may then use such data in partnership with vendors or service providers to market products or materials in his or her building and/or services used during the construction thereof. Designers and specifiers may simply view the dashboard 100 of the member owning a building in which they are interested and view all materials of the BIM, furnishings therein and the contact details of service providers that are or were instrumental in the construction of that building. In this manner, without the designers and specifiers even seeing the building first hand, they may specify materials, products and services as well as service providers (e.g., interior designers, electricians, sheet rock installers, hardscape designers, and the like), with the physical building operating as a virtual catalog of all products, materials and services having contributed to its construction. That is, instead of taking a picture, asking the manager, or chasing down information on say a piece of furniture or paint color, the exact specs are available to the designer or specifier from the dashboard 100. Alternatively, the specifiers and designers may visit the actual building and see and touch the actual items specified on the dashboard 100. The quality of the workmanship of services displayed in the dashboard 100 may also be witnessed first-hand. Moreover, after having chosen the materials, products and/or services, the dashboard 100 enables the designer or specifier to create an RFQ or create or join a group-buy. According to one embodiment, online only vendors are now provided with the equivalent of a brick and mortar “showrooms”, which may be associated with BIM data and GPS coordinates or other location-aware technology. According to one embodiment, the building owner may receive incentives or other value from vendors of the materials, products and services showcased in the dashboard 100 in return for driving traffic and potential customers to their products and services. According to one embodiment, even if a building owner has not uploaded BIM or product or furnishing information to the database supporting the dashboard 100, vendors of such materials, products and services may develop, through the dashboard 100, a portfolio of their green work that prospective clients may view online or actually see and touch, in person. However, privacy considerations laws should be taken into consideration and the sharing of information may be suitably negotiated between the parties.

According to one embodiment, the dashboard 100 may enable governments and regulatory agencies and any properly authenticated and authorized interested party to verify compliance with green mandates and incentives. Indeed, with data such as payback on investments being captured in BIM or the like, performance measures tied to utility use, the database servicing the dashboard 100 may be configured to enable the verification that an entity is complying with the terms of green mandates and incentives. For example, energy mandates sometimes require a predetermined percentage in reduction in energy. Should the dashboard 100 be updated regularly with use metrics, both compliance and the ease with which such compliance may be verified may be enhanced. Moreover, the fact that a building or groups of buildings in a predetermined geographical area have achieved or exceeded the requirements of the mandate may help compliance and policy makers to develop more effective mandates in the future. According to one embodiment, the storage of the terms of future mandates (mandates which have not yet taken effect) in the database(s) supporting the Dashboard 100 enables stakeholders to plan both present and future expenditures. For example, substantial savings may be made by anticipating future mandates, amortizing the costs thereof over a greater time period and/or by achieving a desired green rating earlier than would otherwise be possible or economically-feasible. Moreover, additional savings may be realized by creating group buys to leverage the increased market power of groups to comply with future mandates, before the mandate even takes effect. Such efforts may lead to a greater green certification rating, which may create a better value for investors and higher overall building performance due to improved planning.

As suggested above, the dashboard 100 may be differently configured for different stakeholders. Examples of such stakeholders may include, for example, the building owner, the business owner, hired service providers, architects, contractors, engineers, consultants, persons visiting the location and/or prospective customers interested in the products or services used or offered. Although the dashboard 100 may draw its information from the remote database(s), the information displayed for each of these stakeholders may be customized to display only information that is deemed useful to that stakeholder and to respect confidential information. Embodiments address and solve the problem of transparency or visibility of green products or services/methods used at a particular location. As noted above, many of the green materials, processes and infrastructure used in the construction, maintenance and operation of green facilities may not be apparent to those that were not immediately involved in providing such materials and services. Accordingly, embodiments provide a mechanism for the stakeholders to share such green information associated with a location in a seamless manner. Such green information, according to one embodiment, may comprise valuable incentive, policy, mandate, product or service information and be rendered visible at the location using smartphones, tablets and all manner of mobile computing and location-aware devices

According to one embodiment, each seller (vendor or service provider) may receive a green rating based on the seller's (e.g., company's) green certifications and awards. Their product or services, according to one embodiment, may also be scored and green-rated (based on products certifications or environmentally friendly claims such as saving energy, saving water, minimizing waste, recycled content, VOC content, durability, bio-based content, reusability, renewable energy, recycled packaging, or maintenance/cleaning, for example) for procurement as part of specifying requirements or qualified green materials lists for a project. According to one embodiment, each location (building owner, business owner renting the building, other people relevant to that location such as maintenance manager, contractor, etc.) may also be rated, with their respective scores tied to goals, achievements, timelines, among other possible criteria.

For businesses, sales leads may come in as an active Request for Information (RFI) inquiries and/or may originate from any of the above-described stakeholders (e.g., building owner, business owner, contractor, owner representative, etc.). Some of these sales leads may mature into RFQs and/or may participate in group buys, as detailed above. Sales leads may also be created from the sheer existence of mandates, incentives, rebates, grants, special financing (PACE, payback leasing). For example, older buildings and business that are or that are potentially affected by such mandates, incentives and the like (because they use a large amount of energy, for example) may (even without their knowledge) become sales leads, as they may be more likely to qualify for such funding schemes. Affiliate code (click tracking and rewarding for steering customers to particular websites) may be provided, to enable other sites to bring in such sales leads to a dashboard 100 configured for customers. Sales leads may also, according to one embodiment, be developed through a noted difference between a member's current and desired green rating. Such a disparity may point to possible new financing, offers or specials that would, if accepted, help them achieve their green rating goals.

One embodiment extends the application of the dashboard 100 and the mobile App described above to transportation in general and to vehicles such as automobiles in particular. Indeed, the database supporting the dashboard 100 and the mobile App may be further configured to store green ratings of the auto and information about the auto such as cradle-to-grave (life cycle) green information, including both static data such as, for example, year, make, model, specifications and awards, as well as dynamically-generated information, including any actively calculated or lookup values describing the automobile, diagnostic data and the like. Furthermore, the dashboard 100 and the mobile App may be further configured to support automobile group buys, Original Equipment manufacturer (OEM) or dealer ads/specials.

According to one embodiment, such information may be scrapped from various databases and/or such information may be transmitted from the automobile itself Indeed, automobiles may be configured to comprise embedded controllers with transmission capability. Data collected by such embedded controllers may then be transmitted, in a manner that meets privacy, ownership, FAA, DOE, DOT, etc. requirements. According to one embodiment, the information may be tagged with GPS location information and stored in on-board non-volatile storage. Thereafter, a connection may be made to the user's mobile device (via Bluetooth, for example), which may then transmit the collected information to the cloud for storage in the database or databases supporting the dashboard 100 and mobile App. Is it to be noted that having the ability to “check into” or linking to the auto information in a stationary or moving automobile may be carried out in several ways. The information collected from the automobile may be used to create a new channel of advertising or selling green items or services on the dashboard 100 without a showroom. For example, based on the collected use information, the automobile's owner may be presented, upon signing in to his or her dashboard 100, pertinent ads or specials having particular relevance to their automobile and green goals. Collected information relating to the performance of the automobile may also affect the green rating of the member.

According to one embodiment, tracking the location of the auto (or of the member), via his or her mobile phone, for example, may be used to recommend alternative transportation options, such as carpooling, a shared car service, biking to work incentive programs, and other green incentives. It is to be noted that the user may be given full control over the information that is collected and/or the manner in which the information is used, shared or otherwise disseminated.

Businesses have reviews, address, number of “likes” on social media, number of visits, and often have detailed records on customer visits and purchases. For example, a feed or input from a Google Small Business with GPS coordinates may be used to populate the database supporting the dashboard 100 and the mobile App and such information may affect the member's green rating (e.g., leaves). According to one embodiment, a large set of the data collected may be application program interface (API)-defined with tags, labels, and logic to display only the relevant data in the dashboard 100, depending upon the stakeholder.

For example, in the entertainment field, game makers may utilize the content from the API to create games, such as a scavenger-like hunt for green products and services detailed above. In the education/training/outreach field, institutions and companies may utilize the API to create training materials for classes or location-based learning (GPS driven, for example), for procurement, project management, customer relationship management (CRM), marketing, promotions, group buys, design specifying and policy tracking or mandate verification, to identify but a few possibilities.

According to one embodiment, each stakeholder, RFQ, building, product, service, project, person may be assigned a unique identifier, which identifier may be stored in the database or databases supporting the dashboard 100 and mobile App. Thereafter, the database(s) may be queried across other dimensions such as, for example, mandates, permits, design, goals, specs, green ratings, condition, age, group buys and the like. According to one embodiment, the unique identifier may be associated with GPS or location coordinates, address if any, timeline if relevant, geographic coverage or availability, type, category, classifications, and/or other dimensions or categories, as required.

To facilitate aggregation or group buy opportunities, the concept of coverage is introduced. For example, coverage may be used to help buyers circumscribe the service areas of contractors, or where a product or service may be available. According to one embodiment, the following parameters are identified, which may be linked or combined to define regions. An example of a region, for example, may be a list of zip codes. Such coverage parameters may comprise, for example, address, city block, zip code, area code, county, state and country. Other green-related parameters may be readily devised based on, for example, similar weather or micro-climates, seasonal similarities, regional availabilities of alternative fuels, availability of specific incentives or mandates and the like. Such parameters may be associated with the unique identifiers of the stakeholder, RFQ, building, product, service, project, person whose green information is stored in the database(s) supporting the dashboard 100 and the mobile App.

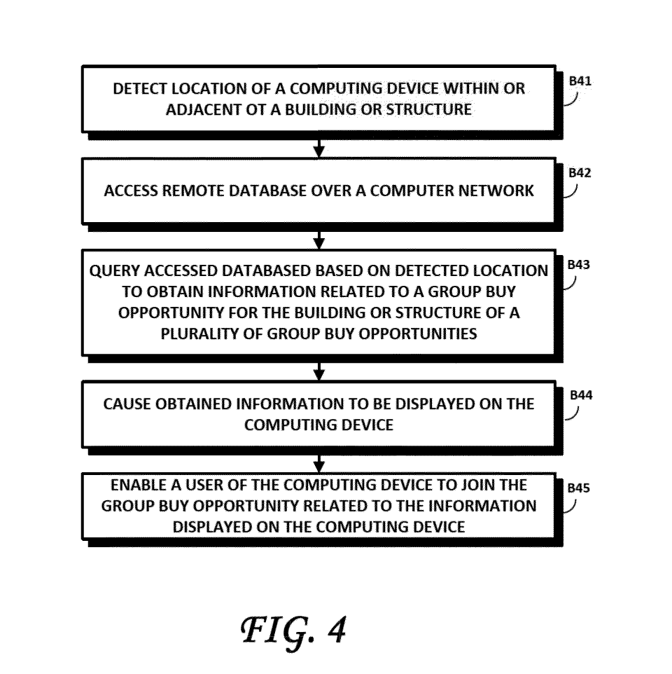

FIG. 4 is a flowchart of a method according to one embodiment. As shown therein, Block B41 comprises detecting a location of a computing device within or adjacent a building or other structure. The computing device may, for example, comprise a mobile device such as a smart phone. Responsive to such detection, a remote database may be accessed over a computer network such as, for example, the Internet as shown at B42. Block B43 calls for the accessed database to be queried based on the detected location, to obtain therefrom information related to one or more group buy opportunities for the building or structure. As shown at B44, the information so obtained from the remote database may then be displayed, in whole or in part, on the computing device. Lastly, Block B45 calls for enabling a user of the computing device to join the group buy opportunity related to the information displayed on the computing device. It is to be noted that the group buy may either succeed or fail, depending upon the number of participants, the negotiated price, deliverables constraints, credit terms, and the like.

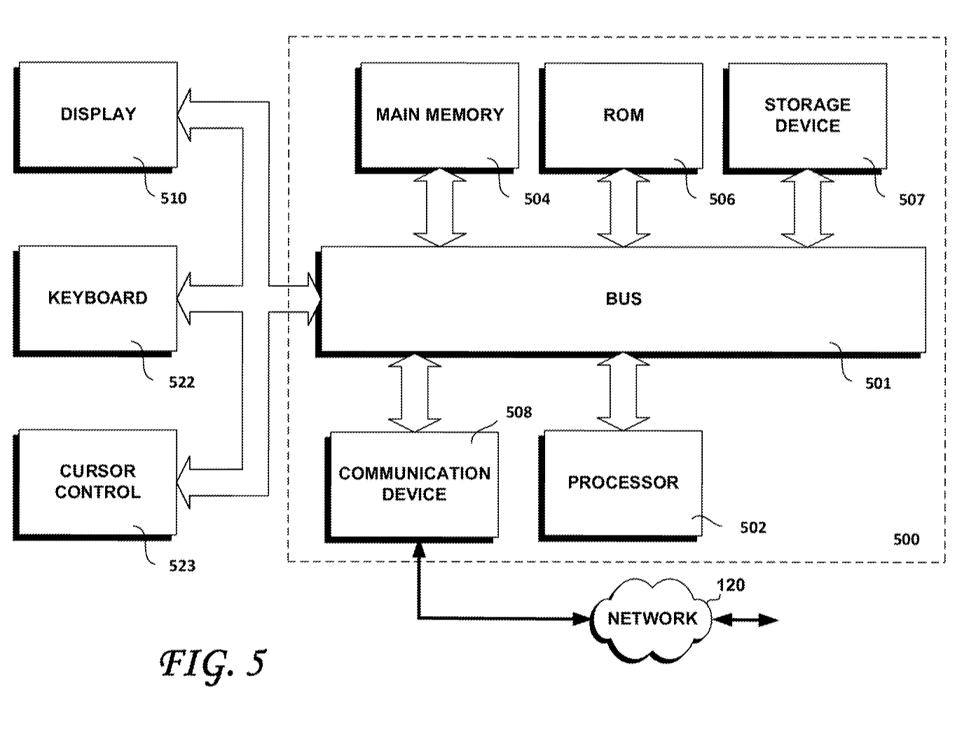

FIG. 5 illustrates a block diagram of a computer system 500 with which embodiments may be implemented. Computer system 500 may comprise a bus 501 or other communication mechanism for communicating information, and one or more processors 502 coupled with bus 501 for processing information. Computer system 500 may further comprises a random access memory (RAM) or other dynamic storage device 504 (referred to as main memory), coupled to bus 501 for storing information and instructions to be executed by processor(s) 502. Main memory 504 also may be used for storing temporary variables or other intermediate information during execution of instructions by processor 502. Computer system 500 also may comprise a read only memory (ROM) and/or other static storage device 506 coupled to bus 501 for storing static information and instructions for processor 502. A data storage device 507, such as a magnetic disk or optical disk, may be coupled to bus 501 for storing information and instructions. The computer system 500 may also be coupled via the bus 501 to a display device 510 for displaying information to a computer user. An alphanumeric input device 522, including alphanumeric and other keys, may be coupled to bus 501 for communicating information and command selections to processor(s) 502. Another type of user input device is cursor control 523, such as a mouse, a trackball, or cursor direction keys for communicating direction information and command selections to processor 502 and for controlling cursor movement on display 521. The computer system 500 may be coupled, via a communication device (e.g., WAN connectivity such as through DSL, cable modem, a broadband mobile phone network, or other connections) to a network 120 and to one or more other computing devices coupled to the network 120.

Embodiments are related to the use of computer system and/or to a plurality of such computing devices for the computer-implemented methods and the functionality described, shown and claimed herein. According to one embodiment, the computer-implemented methods and systems described herein may be provided by one or more computer systems 500 in response to processor(s) 502 executing sequences of instructions contained in memory 504. Such instructions may be read into memory 504 from another computer-readable medium, such as data storage device 507. Execution of the sequences of instructions contained in memory 504 causes processor(s) 502 to spawn or carry out processes that perform the steps and have the functionality described herein. In alternative embodiments, hard-wired circuitry may be used in place of or in combination with software instructions to implement the present invention. Thus, embodiments are not limited to any specific combination of hardware circuitry and software. Indeed, it should be understood by those skilled in the art that any suitable computer system may implement the functionality described herein. The computer system may comprise one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor, or integrated with the microprocessor. In another embodiment, the instructions may be stored on a disk and read into a volatile semiconductor memory before execution by the microprocessor.

While certain embodiments of the disclosure have been described, these embodiments have been presented by way of example only, and are not intended to limit the scope of the disclosure. Indeed, the novel methods, devices and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A computer-implemented method of sharing selected environmental information, comprising:
populating a database with entries corresponding to at least one of selected environmentally-friendly services, objects, materials and building characteristics;
storing the populated database at a remote location over a computer network;
associating the at least one of environmentally-friendly services, objects, materials and building characteristics with respective location coordinates;
identifying a selected location-aware device in close proximity with the respective location coordinates;
generating a notification to the identified location-aware device; and
sending information regarding the at least one of environmentally-friendly services, objects, materials and building characteristics to the location-aware device.

2. The computer-implemented of claim 1, wherein sending comprises at least one of pushing the information to the location-aware device and responding to a query from the location-aware device.

3. The computer-implemented method of claim 1, wherein populating comprises storing dates at which the at least one of selected environmentally-friendly services, objects, materials and building characteristics were implemented.

4. The computer-implemented method of claim 1, wherein sending comprises sending information to the location aware device regarding the services, objects, materials and buildings characteristics that collectively satisfied at least one of a local, state and federal mandate.

5. The computer-implemented method of claim 1, wherein sending comprises sending information to the location aware device regarding manufacturers or installers of the objects, materials and buildings characteristics.

6. The computer-implemented method of claim 1, wherein populating comprises populating the database with Building Information Model (BIM) information and wherein sending comprises sending, to the location aware device, information regarding at least one of environmentally-friendly materials and building processes to the location-aware device.

7. A computer-implemented method of cataloging and sharing information, comprising:
populating a database with entries corresponding to at least one of a vendor's products and materials sold and services rendered, across a plurality of customers of the vendor;
associating location coordinates to each of the plurality of customers and storing the associated location coordinates in the database;
configuring an application for execution on a mobile computing device, the application being configured selectively access the database over a computer network and to selectively display, on the mobile device, information related to at least one of the vendor's products, materials and services when the mobile device is at or approaches the location coordinates of one of the vendor's customers.

8. The computer-implemented method of claim 7, wherein the location coordinates comprise global positioning satellite (GPS) coordinates.

9. The computer-implemented method of claim 7, wherein the location coordinates comprise indoor location coordinates.

10. The computer-implemented method of claim 7, wherein the services rendered comprise building and construction services.

11. The computer-implemented method of claim 10, wherein populating comprises storing building information model (BIM) information in the database.

12. The computer-implemented method of claim 10, wherein populating comprises storing building and construction services rendered to meet at least one of an environmental mandate and incentive.

13. The computer-implemented method of claim 7, wherein configuring the application comprises enabling the mobile computing device to selectively display information related to at least one of the vendor's products, materials and services towards which the mobile device is pointed.

14. The computer-implemented method of claim 7, wherein the selectively displayed information comprises at least one of a brand, quantity, size, price and availability of the vendor's products, materials and services.

15. The computer-implemented method of claim 7, wherein configuring the application comprises enabling a user of the mobile device to create or join an existing group buy of at least one of the vendor's products, materials and services displayed on the mobile computing device.

16. A computer-implemented method for a mobile computing device to provide environmental information, comprising:
detecting a location of the mobile computing device within or adjacent to a building or structure;
accessing a remote database over a computer network;
querying the accessed database based on the detected location;
receiving environmental information associated with the building or structure from the database over the computer network; and
selectively displaying the received environmental information on the mobile computing device based upon received user selections.

17. The computer-implemented method of claim 16, wherein detecting the location comprises receiving global positioning satellite (GPS) coordinates.

18. The computer-implemented method of claim 16, wherein the environmental information comprises information related to services rendered during construction or maintenance of the building or structure.

19. The computer-implemented method of claim 18, wherein the services comprise construction and maintenance services rendered to meet at least one of an environmental mandate and incentive.

20. The computer-implemented method of claim 16, wherein the database comprises building information model (BIM) information.

21. The computer-implemented method of claim 16, wherein selectively displaying comprises displaying the received environmental information on a mobile computing device at the detected location.

22. The computer-implemented method of claim 21, wherein selectively displaying comprises displaying information related to at least one of products, materials and services towards which the mobile device is pointed.

23. The computer-implemented method of claim 22, wherein the selectively displayed environmental information comprises at least one of a brand, quantity, size, price and availability of products, materials and services.

24. A computer-implemented method, comprising:
detecting a location of a computing device within or adjacent to a building or structure;
accessing a remote database over a computer network;
querying the accessed database based on the detected location to obtain information related to a group buy opportunity for the building or structure of a plurality of group buy opportunities;
causing the obtained information to be displayed on the computing device; and
enabling a user of the computing device to join the group buy opportunity related to the information displayed on the computing device.

25. The computer-implemented method of claim 24, wherein the group buy opportunity is associated with a unique Group Buy Identification Number (GIN).

26. The computer-implemented method of claim 24, wherein the database is configured to store information related to present and future building-related mandates and incentives.

27. The computer-implemented method of claim 24, wherein the group buy opportunity is configured to satisfy a mandate or to take advantage of an incentive.

28. The computer-implemented method of claim 24, wherein enabling comprises enabling the user to cause execution of a command enabling the user to join the group buy information displayed on the computing device.

29. The computer-implemented method of claim 24, wherein the database is further configured to comprise Building Information Model (BIM) information.

30. The computer-implemented method of claim 24, further comprising auto-generating the group-buy opportunity based upon the obtained information.
